(19) United States
(12) Patent Application Publication
(10) Pub. No.: US 2010/0052554 A1
(43) Pub. Date: Mar. 4, 2010

(54) Cell Arrangement for Feeding Electrical Loads such as Light Sources, Corresponding Circuit and Design Method

(75) Inventor: Nicola Zanforlin, Campodarsego (IT)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Gesellschaft mit beschänkter Haftung, Munich (DE)

(21) Appl. No.: 12/520,866

(22) PCT Filed: Dec. 21, 2006
(86) PCT No.: PCT/IT06/00864

§ 371 Date: Oct. 22, 2009

(51) Int. Cl. H05B 37/02; H02J 3/00

(52) U.S. Cl. 315/210; 307/31

(57) ABSTRACT

A circuit arrangement for driving electrical loads such as High Flux (HF) LEDs used as lighting sources. The circuit arrangement includes: a switched power source (10) providing a voltage signal switched with a switching frequency (Fsw) and having a given amplitude (Vout), and a plurality of cells (20) connected to the switched power source (10), wherein the LED cells (20) each include an LC decoupling impedance (50) for defining the intensity of the current flowing into the LED cell (30) from the switched power source (10). The LC decoupling impedance (50) includes LC components defining a resonance frequency (Fres) such that the switching frequency (Fsw) of the switched power source (10) is about one half the resonance frequency (Fres) of the LC decoupling impedance (50), whereby the average intensity of the current flowing into the cell is kept constant irrespective of the load on the LED cell (20).

### FIELD OF THE INVENTION

The invention relates to feeding electrical loads such as light sources, e.g. Light Emitting Diodes (LEDs).

The invention was devised by paying specific attention to its possible application to High Flux (HF) LEDs, which are being increasingly used as lighting sources. Reference to this preferred field of application is not however to be construed in a limiting sense of the scope of the invention.

### DESCRIPTION OF THE RELATED ART

Within the context mentioned in the foregoing, the need frequently arises of paralleling several cells including light sources such as semiconductor light sources that require a constant current like LEDs.

So far, this problem has been solved essentially in two ways, namely:

by adding one current regulator for each individual cell, if the cells are fed from a voltage controlled source, or

by associating to each cell some sort of decoupling network if the cells are fed via a High Frequency (HF) generator.

Those solutions that require a current regulator for each cell are intrinsically complex and expensive, especially for low-cost applications. Solutions resorting to decoupling networks may introduce HF ripple in the signal fed to light source or sources such as the LED or LEDs associated with the cell, which inevitably reduces the useful lifetime of these light sources.

### OBJECT AND SUMMARY OF THE INVENTION

The object of the present invention is to provide an improved arrangement which is simple and inexpensive to produce, while also giving the possibility of avoiding the presence of HF ripple in the signal supplied to electrical loads such as LED or LEDs and/or individually dimming each light source in a circuit arrangement including a plurality of cells connected to a single power source.

According to the present invention, this object is achieved by means of a cell arrangement having the features set forth in claim 1. Advantageous developments of the invention form the subject matter of the dependent claims. The invention also relates to a circuit arrangement including a plurality of such cells as well as a method for designing such a circuit arrangement. The claims are an integral part of the disclosure of the invention provided herein.

The arrangement described herein provides i.a. the following advantages:

a simple system structure;

a simple and accurate current control based on passive elements, so that the current fed to each light source cell can be individually trimmed;

each individual cell/light source can be independently dimmed;

new cells can be added to an existing arrangement without adversely affecting the behaviour and performance of the existing arrangement; and

a good efficiency in the main power supply and a good active/reactive power ratio at full load.

The possible use of the arrangement described herein is in no way limited to LED cells.

The arrangement described herein can be used to advantage for all kind of light sources that require a constant current to work properly. For example, one or more discharge lamps can be supplied from the same HF power source arrangement described herein without the use of output rectifiers. For this kind of light sources a power control is usually performed in the place of a current control as these lamps can exhibit a negative impedance that renders current control very difficult to perform in certain cases.

The arrangement described herein avoids any feedback-based control system; since the current fed to each load is automatically defined by the decoupling impedance associated therewith the impedance behaviour becomes irrelevant.

Even an halogen lamp—which is usually driven via a HF voltage source (electronic transformer—e.g. Halotronic)—can be connected in parallel to a HF power supply by choosing the right impedance. Also in this case rectifiers can be dispensed with and the HF current can be directly applied to the lamp.

More generally, any kind of electrical load (even if not related to lighting) that requires a constant current can be connected to the bus arrangement described herein. Exemplary of such a load is a battery charger for which the correct impedance can be identified once the charge current has been selected.

To sum up, the preferred bus-like embodiment of the arrangement described herein can be used for feeding different kinds of electrical loads such as light sources that require constant currents, even in the presence of different supply currents for each load.

The bus arrangement described herein is thus versatile and easy to use. For instance, if a new technology adopted for one of the loads fed via the bus arrangement presents new requirements in terms of current, the main power supply does not require to be changed and the different requirement in terms of current can be accommodated by changing the decoupling impedance e.g. in order to permit a higher current to be fed to the new load (of course, by taking into account the general limitation in terms of maximum available power).

### BRIEF DESCRIPTION OF THE ANNEXED REPRESENTATIONS

The invention will now be described, by way of example only, with reference to the annexed representations, wherein:

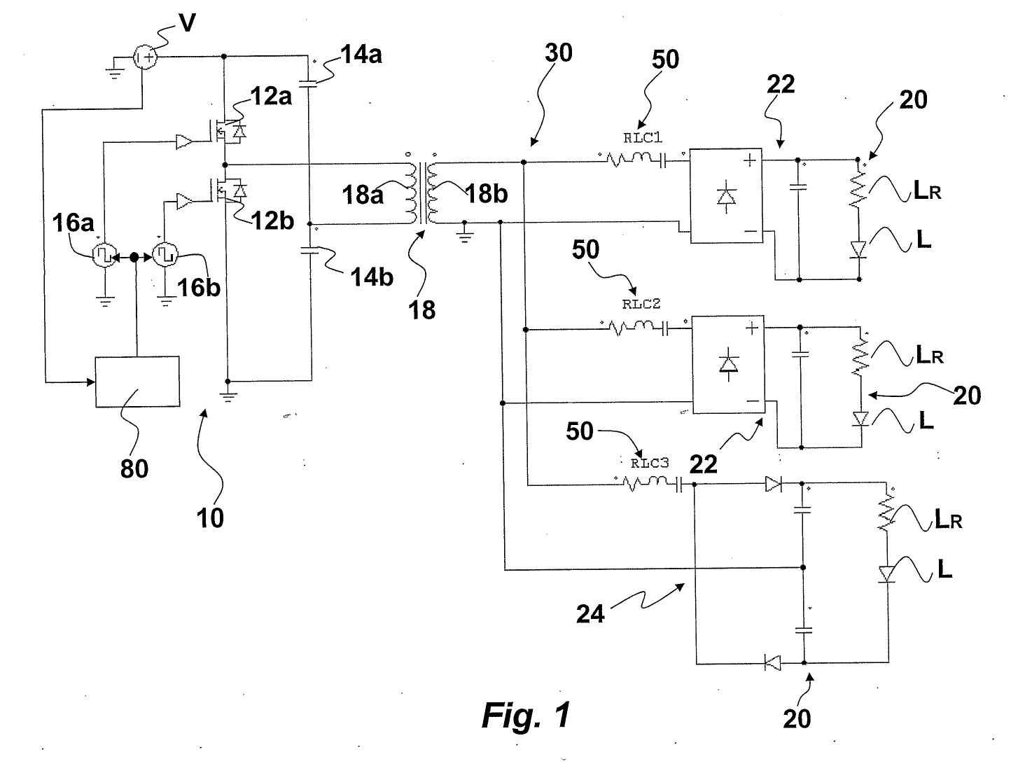

FIG. 1 is a schematic block diagram of a circuit arrangement including a plurality of cells as described herein,

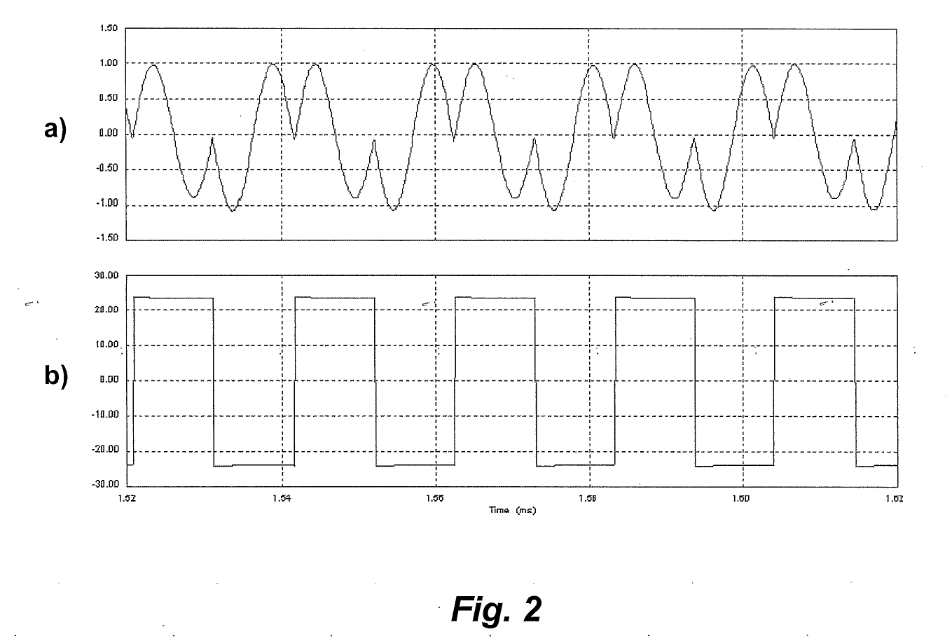

FIGS. 2 to 4 are exemplary diagrams representative of the time behaviour of signals useful in understanding operations of the arrangement described herein,

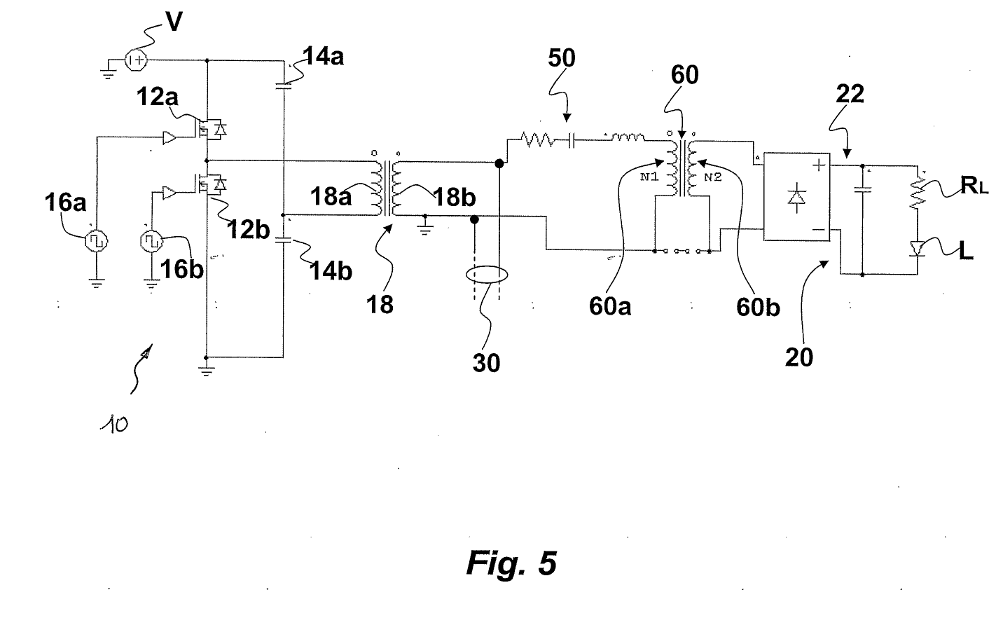

FIG. 5 is another block diagram showing a development of the arrangement shown in FIG. 1,

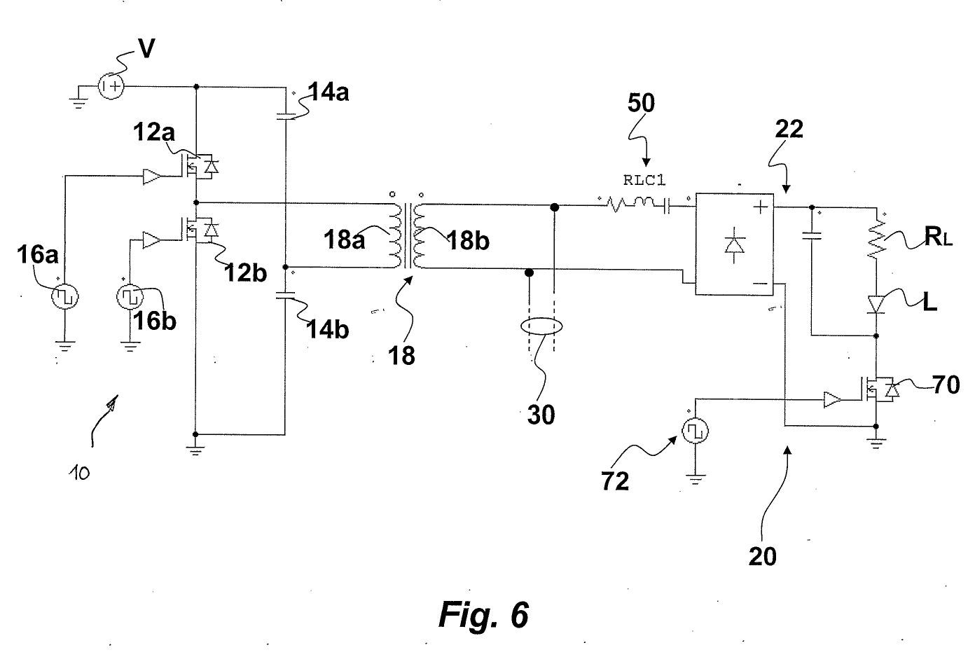

FIG. 6 shows an advantageous improvement adapted to be used in connection with both embodiments of FIGS. 1 and 5, and

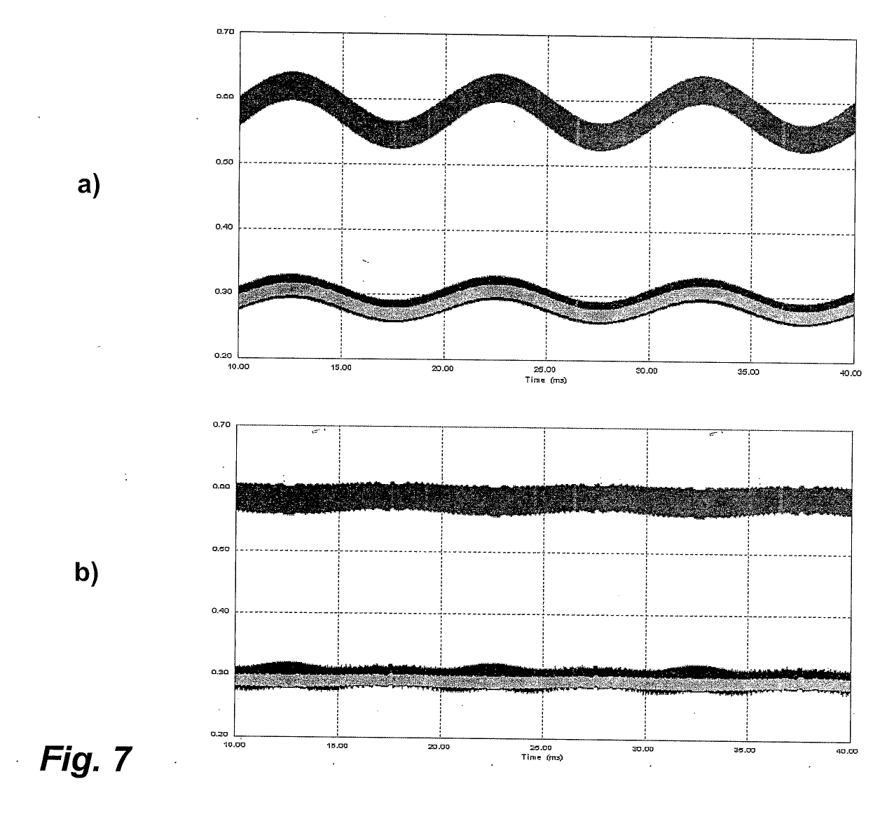

FIG. 7 is another time diagram representative of operation of the arrangement described herein.

### DETAILED DESCRIPTION OF EXEMPLARY EMBODIMENTS

In general terms, FIGS. 1, 5, and 6 all refer to circuit arrangements including:

a power source 10, and

a plurality of cells 20 having associated respective electrical loads here represented by light sources such as semiconductor light sources, e.g. LEDs.

In the exemplary embodiments described herein, each cell 20 includes one or more light sources. Throughout this exemplary description, LEDs will be considered as exemplary of these light sources. LEDs such as High Flux (HF) LEDs are represented from the electrical viewpoint as the series connection of a diode L and an associated parasitic resistor LR.

The various LED cells 20 are connected to the power source 10 via a connecting structure 30 which essentially takes the form of a bus-like structure. The circuit arrangement described herein makes it possible to connect to the bus structure 30 several LED cells 20 which may be configured to draw different, fixed current values based on the specific requirements of the cell. For the sake of simplicity, a single LED cell 20 is shown in the block diagrams of FIGS. 5 and 6; it will however be understood that the related circuit arrangements will in fact include a plurality of LED cells 20 (for instance three LED cells) as shown in FIG. 1.

Typically, the power source 10 takes the form of a high frequency source adapted to deliver onto the bus structure 30 a voltage signal comprised of a square wave with a constant amplitude Vout, e.g. a signal switching with a frequency Fsw of e.g. 48 kHz between +Vout and −Vout, with |Vout| notionally constant—save for the possible presence of voltage ripple as better discussed in the following.

In the exemplary embodiment considered herein, the power source 10 is a half-bridge inverter including two electronic switches 12a, 12b (such as two MOSFETs) connected in a half-bridge arrangement together with two capacitors 14a, 14b. According to a well known operating principle, the two switches 12a, 12b are alternatively switched on and off with the frequency Fsw by two respective drive sources 16a, 16b to alternatively connect an input DC voltage V to the primary winding 18a of a transformer 18. A square wave output with a switching frequency Fsw as previously described is thus fed to the bus structure 23 via the secondary winding 18b of the transformer 18.

Each cell 20 includes a rectifier module. This may be comprised of a full-bridge rectifier 22 (as is the case of the two upper LED cells 20 in FIG. 1 and the LED cells of FIGS. 5 and 6) or a voltage doubler structure 24 as schematically shown for the lower LED cell 20 in FIG. 1. In a further alternative arrangement (not shown) the LED cell 20 may include a voltage multiplier in the place of the voltage doubler 24. Any of the rectifier module and the voltage doubler/multiplier are structures well known per se and do not require to be described in the detail herein.

Rectification is thus split on each LED cell 20 and the equivalent LED voltages as “seen” by the power source (i.e. the inverter 10) is not in excess of the output voltage of the power source. If, for example, the voltage applied to the bus structure 30 is a square wave switching between +24V and −24V, the LED cells 20, if connected using a full bridge rectifier, have a maximum forward voltage not in excess of 24 volt. A LED cell with a higher maximum forward voltage (for instance in the range of 48V) is connected using a voltage doubler (see element 24 in FIG. 1) or voltage multiplier.

In the block diagrams of FIG. 1, 5 and 6 the LED cells 20 are connected to the inverter output via the bus 30 with the interposition of LC (inductive-capacitive) decoupling impedances 50. Each impedance 50 is shown as comprised of a resistor R (which is representative of the losses in the impedance and can in fact be neglected for the purposes of the description that follows), an inductor L and a capacitor C. The various decoupling impedances 50 shown in FIG. 1 are denoted RLC1, RLC2, RLC3 in order to emphasize that—as better detailed in the following—the value of the inductance for the inductor L and the value of the capacity of the capacitor C can be selected differently for each decoupling impedance 50.

The arrangement described herein relies on the ability of the LC impedance to maintain a constant (average) value of current at the input of each LED cell 20 irrespective of the load in turn applied to the cell output as represented by the LED or LEDs—e.g. irrespective of whether such a cell output is short-circuited or loaded at maximum load.

These results can be achieved provided the following requirements are met:

the output voltage of the power source, that is the inverter 10, has a substantially constant amplitude ±Vout (save for the possible presence of ripple superposed thereon), and

the inverter frequency Fsw is about one half the resonance frequency Fres=1/(2π√(LC)) of the decoupling impedance.

Stating that the power source frequency Fsw is “about” one half the LC resonance frequency Fres is evidently intended to highlight that the arrangement described herein is capable of operating in a fully satisfactory way even if the relationship Fsw=Fres/2 is not exactly met. The inherent tolerances related to practically obtaining such a relationship must in fact be taken into account, and the experiments carried out so far by the Applicant show that in typical situations Fsw will be slightly lower than one half of Fres. Additionally, in the final part of this description, the possibility will be described of causing the frequency Fsw to “wobble” about ±5-6% with respect to its nominal value in order to compensate the ripple possibly superposed on the feed voltage V (see FIG. 1).

If the conditions above are met, the current applied to each individual LED cell 20 via the bus 30 will have a substantially constant average value defined by the characteristic impedance Zo=√(L/C) of the decoupling impedance.

Practical operation of the arrangements shown in FIG. 1, FIGS. 5 and 6 may be best understood by referring to the diagrams of FIGS. 2 to 4. Each of these diagrams is comprised of two superposed portions, denoted (a) and (b), respectively. The diagrams of FIGS. 2a to 4a are representative of the time behaviour of the voltage across the LED cell load (i.e. the LED or LEDs L), while the diagrams of FIGS. 2b to 4b are representative of the time behaviour of the voltage at the LED input. In all the diagrams of FIGS. 2 to 4 the abscissa scale is representative of time (milliseconds—with a slightly amplified scale in the case of FIG. 2), while the ordinate scale is representative of the voltage signal amplitude (Volt).

The diagrams of FIG. 2 refer to a LED cell 20 being short-circuited at its output (or having an output voltage close to 0). The maximum current is Ires=Vout/Zo. When the voltage Vout is applied to this cell, the current on the corresponding LC impedance, will start from zero to reach a maximum positive value and then a minimum negative value to finally return to zero with a time trajectory which can be essentially paralleled to a portion of a sinusoidal waveform. This process re-starts when a voltage with the opposite polarity is applied by reaching first a negative peak.

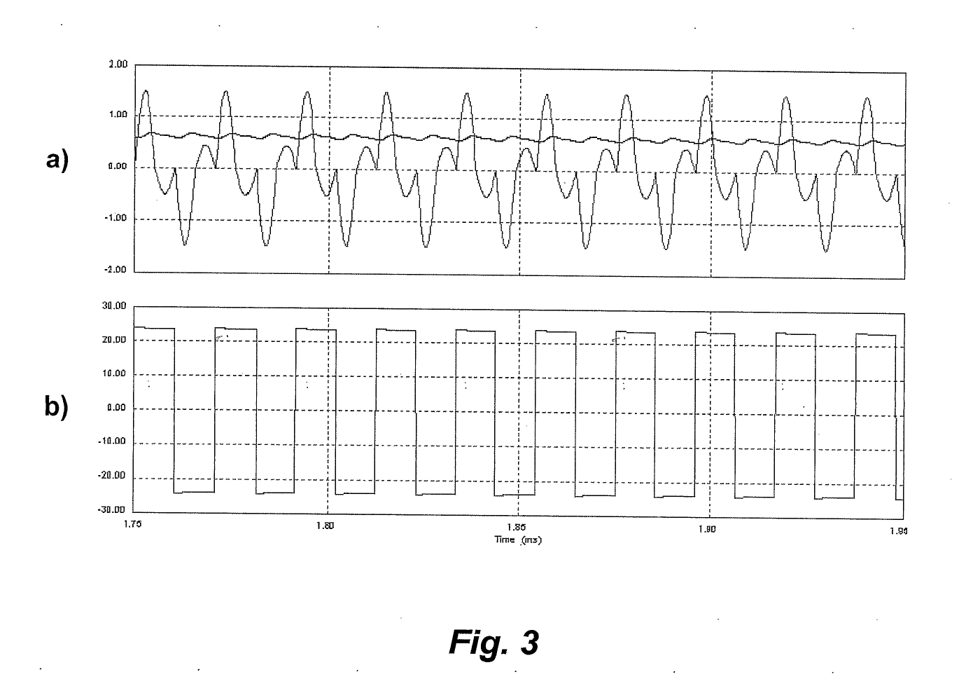

If the load at the cell output increases, the first peak current increases and the second peak decreases. However, the second peak decreases in such a way to keep constant the absolute value of the average current, as schematically shown in FIG. 3.

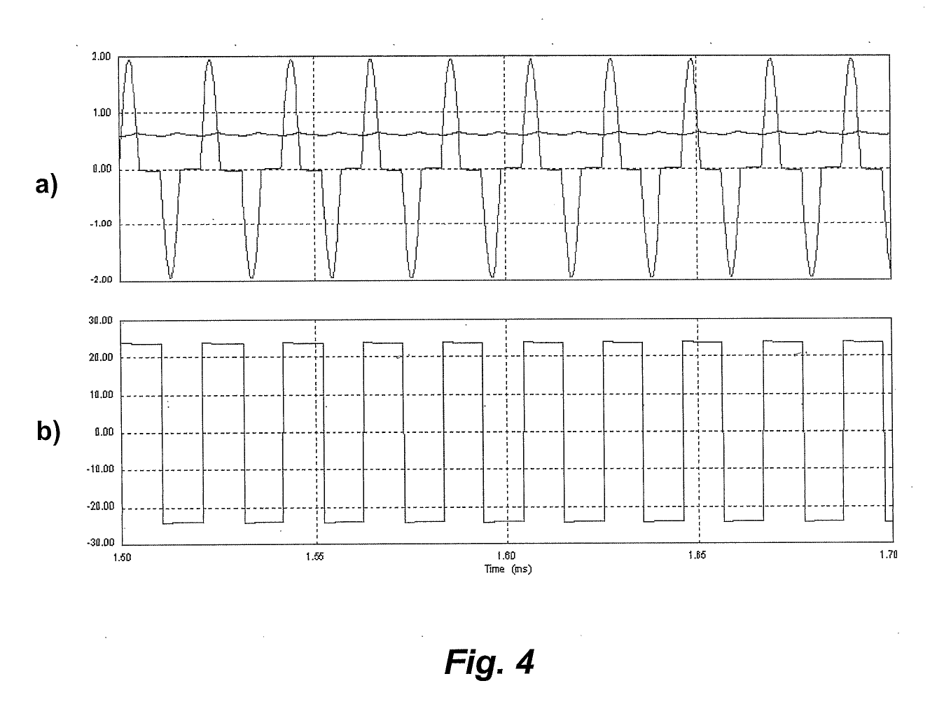

Finally, if the voltage on the cell load approaches the value Vout, the first peak reaches a maximum value, while the second peak is almost zero, as schematically shown in FIG. 4.

In all the cases considered, the absolute value of the average current is constant and its value is Iavg=Ires_Max/π where Ires_max=2*Vout/Zo. This value is reached when the load voltage is slightly less than Vout (as better perceived by looking at FIG. 4).

An arrangement as shown in general in FIG. 1 may thus be designed on the basis of the process described in the following, i.e. a process relying on the basic concept of selecting the LC components of the LC decoupling impedance 50 of each cell 20 such that the switching frequency Fsw of the power source (i.e. the inverter 10) is about one half the resonance frequency Fres of the LC decoupling impedance 50.

Preferably, as a first step in the design process, the characteristics of the power source 10 are considered. The term “considered” is used to highlight the fact the power source 10 may in fact be a source already existing and available. In the case of the embodiment shown, the switching frequency Fsw of the inverter and the turn ratio of the transformer 18 which define the amplitude of the alternate voltage Vout are the main characteristics considered.

Then, the value of the decoupling impedance Zo of each cell 20 is defined as a function of the (average) current intensity as desired for the cell: in the case of LEDs used as lighting sources, this current intensity is typically dictated by the desired lighting power.

The values of the two reactive elements (inductance L and capacitor C) of the decoupling impedance 50 can thus be selected in such a way to have a resonance frequency Fres which is approximately (notionally identical) to twice the inverter frequency Fsw, i.e. Fsw=Fres/2. The corresponding relationships, namely Zo=√(L/C) and Fres=1/(2π√(LC)) identify in univocal manner the values for L and C.

The block diagram of FIG. 5 refers to a possible development of the basic scheme of FIG. 1: once again it is recalled that in the block diagrams of FIGS. 5 and 6 a single cell 20 is shown for the sake of simplicity, while in fact the related arrangement includes plural cells.

Specifically, FIG. 5 refers to the case where a specific voltage is required at the output of the LED cell 20. In that case, a transformer 60 having primary and secondary windings 60a and 60b, respectively, is interposed between the decoupling impedance 50 and the rectifier 22 of the cell 20. Optional insulation between the primary and the secondary side of the transformer 60 may be optionally provided.

Due to the presence of the transformer 60 the maximum voltage VLED max on the LED or LEDs is VLED_max=Vout_max*N2/N1, where N2/N1 is the secondary-to-primary turn ratio of the transformer 60.

The transformer 60 notionally permits to obtain any exact desired value for the voltage VLED max. Conversely, a voltage multiplier (as the voltage doubler indicated 24 in FIG. 1) will permit to obtain for VLED_max only a value that is an integer multiple of the voltage Vout.

In the case where the transformer 60 is present, the impedance Zo will be selected by taking into account the transformer turn ratio N2/N1. The impedance Zo must thus be decreased in order to increase the current on the primary side of the transformer according to the average power balancing Pin_trafo=Pout_trafo=P_LED_cell, where the three members in the equation represent the input power to the transformer, the output power from the transformer, and the power applied to the LED cell element casketed thereto, respectively.

It will be appreciated that the inductive component L of the decoupling impedance 50 may be at least partly represented by (i.e. may either include or be completely comprised of) the leakage inductance Llk of the transformer 60. By keeping the turn ratio N2/N1 constant, the specific numbers of turns N1 and N2 can be varied in order to obtain the desired value for Llk.

If an insulated voltage is not required, an auto-transformer (not insulated) with a lower number of turns and a simpler mechanical structure can be used as the transformer 60.

In the arrangement described therein, reactive elements can be used having values are significantly higher than the parasitic parameters of the wires comprising the bus 30. Consequently, the arrangement described herein exhibits good immunity against the negative effects of the parasitic parameters. The bus 30 may be comprised of wires with lengths of some meters thus creating a real bus structure to which each individual LED cell 20 can be connected by providing a simple, passive LC decoupling impedance 50 without the need of resorting to additional switching or post-regulators. Additionally, the arrangement described herein insures a good ratio between the reactive power and the active power (that is the active power supplied to the LED cells) flowing over the bus 30. This ratio tends to decrease as the output power increases because of the increased voltage on the LED cells. This is an advantage, as the efficiency increases as the power drawn by the load increases. When the voltage Vcell on the cells reaches its limit value (Vout, namely the peak voltage from the inverter 10) the reactive power is slightly more than 1.5 times the active power.

An additional, significant advantage of the arrangement described herein lies in that each LED cell 20 can be independently dimmed by resorting to a Pulse Width Modulation (PWM) scheme using a low frequency electronic switch 70 (see the block diagram of FIG. 6) such as a MOSFET, associated to the LED L. The dimming switch 20 is driven (in a manner known per se, which does not require to be described in detail herein) by a PWM-modulated dimming driver 72.

The switch 70 can be connected either in series or in parallel the LED or LEDs.

In parallel connection (not specifically illustrated) the switch 70 is connected across the assembly comprised of the LED ot LEDs L and the resistance R_{L}, so that the switch 70, when conductive, short circuits the LED or LEDs.

Parallel connection (adapted for LEDs that are ground referenced) has the advantage of lending itself to implementation by using a cheap low-side driver. This approach can be adopted in view of the fact that the short-circuit current is completely controlled (the LED cell draws from the bus 30 the same average current even if short-circuited). In fact, the current flows through the switch 70 instead of flowing through the LED or LEDs. This leads to a small amount of power being dissipated in the wires and the components without any useful (i.e. light) output.

As an alternative (to which the block diagram of FIG. 6 specifically refers) the switch 70 can be series-connected with the LED or LEDs in the cell in such a way to disconnect the cell 20 from the ground when the switch 70 is not conducting. This arrangement is advantageous in that no reactive power will flow along the bus 30 when the cell 20 is disconnected from the ground.

Experiments performed so far by the Applicant show that fully satisfactory results can be obtained by feeding the arrangement described herein (with or without dimming capability) with a double-stage converter, where the high voltage DC input (V in FIG. 1) used as an input to the inverter 10 is generated by using a Power Factor Corrector (PFC) power stage. Using a PFC is recommended in lighting applications for input powers equal or in excess of 25 W to meet regulations related to harmonic currents. A PFC is a position to generate a high DC voltage that allows the inverter 10 to work in conditions that are ideal for the application contemplated herein.

A PFC stage typically generates a 100 Hz sinusoidal voltage ripple on the intermediate capacitor (about ±5%), which tends to be transferred on the output current of each LED cell 20 connected.

It is thus advantageous to sense the PFC voltage and to modulate the switching frequency Fsw of the inverter 10 around its working point in order to compensate for this ripple.

In the block diagram of FIG. 1, reference 80 designates a control module associated (in a known manner) to the PFC stage that generates input voltage V to sense the instantaneous value of the voltage V. The control module 80 acts on the switching frequency Fsw of the switches 12a, 12b to cause a “wobbling” (i.e. swinging) effect of the frequency Fsw around its center value proportional to the ripple i.e. proportional to the difference between the instantaneous value of the voltage V and its nominal value (average controlled voltage). This swinging proportional to ripple is caused to occur in such a way that, during the half-period when the instantaneous voltage from the PFC stage is higher than the average controlled voltage V, the frequency Fsw is decreased (i.e. swept downwardly—about 5-6% maximum) while, during the other half-period, i.e. when the instantaneous voltage from the PFC stage is lower than the average controlled voltage V, the frequency Fsw is increased (i.e. swept upwardly—of the same amount).

Even in the presence of such a moderate (10-12%) frequency swing, the inverter frequency Fsw will still be about half the resonance frequency Fres=1/(2π√(LC)) of the decoupling impedances of the various LED cells 20.

Modulation/wobbling of the frequency Fsw as described will cause the 100 Hz ripple on the LEDs to be almost completely dispensed with. Additionally, by varying the inverter frequency Fsw, a further advantage is achieved in terms of Electro-Magnetic Interference (EMI) produced by the inverter output stage. This is due because the modulation of the frequency Fsw leads to the electromagnetic noise produced by the inverter 10 being spread over a band of frequencies thus reducing the peak of each single harmonic.

The compensation scheme in question can be implemented by resorting to a feed-forward control from the input, without the need of any feedback from the output, that is without the need of additionally components such as a shunt, a controller and a safety optocoupler.

In the experiments performed so far by the Applicant particularly satisfactory results were achieved, in the case of the arrangement shown in FIG. 1 where the following parameters are used:

switching frequency Fsw of the inverter 10=48 KHz;

DC voltage V of 400V with a sinusoidal ripple of ±25V (typical PFC output),

values of the decoupling impedances Zo of 24.25 Ohm, 12.12 Ohm, and 24.25 Ohm for the first, second and third LED cells 20, respectively.

It will be appreciated that the third cell 20 (bottom part of FIG. 1) includes a voltage doubler structure, which means that the cell current is one half in comparison with a similar cell with full-bridge rectification.

FIG. 7 of the annexed representations includes two superposed diagrams designated (a) and (b), respectively.

The diagram designated (a) shows, with reference to time abscissa scale indexed in ms, the values of the currents flowing through the three cells 20. Specifically, the upper curve is representative of the current flowing through the first cell 20, having an average current of about 600 mA, while the two lower superposed curves are indicative of the currents flowing through the two other cells with average currents of about 300 mA.

A 100 Hz ripple is clearly visible superposed to all of the three currents.

Conversely, the diagram of figure (b) shows the time behaviour of the same three currents when the switching period (that is the frequency Fsw) of the inverter 10 is varied as described in the foregoing. The diagram of FIG. 7b clearly shows how ripple compensation can be achieved in that way.

Of course, without prejudice to the underline principles of the invention, the details and embodiments may vary, also significantly, with respect to what has been described in the foregoing, merely by way of example, without departing from the scope of the invention as defined by the annexed claims.

1. A cell for feeding at least one electrical load with a switched power source providing a voltage signal switched with a switching frequency and having a given amplitude, the cell including an LC decoupling impedance having an impedance value that defines the intensity of the current flowing into the cell from said switched power source, wherein said LC decoupling impedance includes LC components defining a resonance frequency of said LC decoupling impedance such that said switching frequency of said switched power source is about one half said resonance frequency of said LC decoupling impedance.

2. The cell of claim 1, including a rectifier to be interposed between said LC decoupling impedance and said at least one electrical load.

3. The cell of claim 1, including a voltage doubler to be interposed between said LC decoupling impedance and said at least one electrical load.

4. The cell of claim 1, including a voltage multiplier to be interposed between said LC decoupling impedance and said at least one electrical load.

5. The cell of claim 1, including a transformer to be interposed between said LC decoupling impedance and said at least one electrical load.

6. The cell of claim 5, wherein the leakage inductance of said transformer is included in the L component of said LC decoupling impedance.

7. The cell of claim 5, wherein the leakage inductance of said transformer comprises the L component of said LC decoupling impedance.

8. The cell of claim 5, wherein said transformer is an auto-transformer.

9. The cell of claim 1, wherein said at least one electrical load includes a light source.

10. The cell of claim 9, including a dimming arrangement for selectively dimming said light source.

11. The cell of claim 10, wherein said dimming arrangement includes a switch for PWM dimming said light source.

12. The cell of claim 11, wherein said switch is an electronic switch such as a MOSFET.

13. The cell of claim 11, wherein said switch is arranged for parallel connection with said light source.

14. The cell of claim 11, wherein said switch is arranged for series connection with said light source.

15. The cell of claim 1, including said at least one electrical load.

16. The cell of claim 1, wherein said at least one electrical load includes a Light Emitting Diode.

17. A circuit arrangement comprising:
a switched power source providing a voltage signal switched with a switching frequency and having a given amplitude, and
a plurality of cells connected to said switched power source, said plurality of cells including cells according to claim 1.

18. The arrangement of claim 17, wherein said plurality of cells are connected to said power source via a bus-like arrangement.

19. The circuit arrangement of claim 17, wherein said switched power source is an inverter such as a half-bridge inverter.

20. The circuit arrangement of claim 17, wherein said switched power source is configured for being powered via a DC voltage source having a voltage ripple superposed to the nominal DC voltage supplied to said switched power source, and wherein said switched power source includes a controller for selectively modulating said switching frequency to decrease, respectively increase, said switching frequency as said voltage from said DC voltage source is higher, respectively lower than said nominal DC voltage as a result of said ripple superposed thereto.

21. A method of designing a cell for feeding at least one electrical load by means of a switched power source providing a voltage signal switched with a switching frequency and having a given amplitude, wherein the cell includes an LC decoupling impedance, wherein the method comprises the step of selecting the LC components of said LC decoupling impedance to have a resonance frequency such that said switching frequency of said switched power source is about one half said resonance frequency of said LC decoupling impedance.

22. The method of claim 21, comprising the steps of:
defining a desired current intensity to flow into said cell from said switched power source, and
selecting the impedance value of said LC decoupling impedance as a function of said constant amplitude voltage to give said desired current intensity, whereby said resonance frequency and said impedance value identify univocal values for the L and C components of said LC decoupling impedance.

23. The method of claim 21, comprising the steps of designing a transformer to be interposed between said LC decoupling impedance and said at least one electrical load, and selecting the number of turns for said transformer to yield a leakage inductance for said transformer, said leakage inductance constituting at least part of the L component of the said LC decoupling impedance.
